(19) United States
(12) Patent Application Publication
(10) Pub. No.: US 2009/0130270 A1
(43) Pub. Date: May 21, 2009

(54) INFUSION METHOD AND DEVICE FOR SELECTIVELY PRODUCING 'AMERICAN' AND 'ESPRESSO' COFFEE FROM THE SAME CAPSULE OF GROUND COFFEE

(75) Inventor: Virginio Cortese, Torino (IT)

Correspondence Address: LADAS & PARRY LLP, 26 WEST 61ST STREET, NEW YORK, NY, 10023, US

(73) Assignee: SGL ITALIA S.r.l., Torino (IT)

(21) Appl. No.: 11/631,047

(22) PCT Filed: Jun. 23, 2005
(86) PCT No.: PCT/EP2005/052951

§ 371 Date: Feb. 3, 2009

(30) Foreign Application Priority Data
Jun. 29, 2004 (IT) TO2004A 000441

(51) Int. Cl. A23F 5/00; A47J 31/24

(52) U.S. Cl. 426/281; 99/295

(57) ABSTRACT

A coffee percolator whereby “American” and “espresso” coffee are selectively produced from the same capsule of ground coffee by adjusting the degree of compaction of the ground coffee in the capsule as a function of the type of coffee selected.

### TECHNICAL FIELD

The present invention relates to an infusion method and device for selectively producing “American” and “espresso” coffee from the same capsule of ground coffee.

### BACKGROUND ART

In coffee percolation, the same capsule is known to be used to produce both “American”, i.e. weak, coffee and “espresso” coffee.

The type of coffee produced depends on the structural characteristics of the infusion device employed, which can only be used to produce one type.

### DISCLOSURE OF INVENTION

It is an object of the present invention to provide an infusion method which, in a straightforward, low-cost manner, provides for selectively producing “American” coffee and “espresso” coffee from the same capsule of ground coffee.

According to the present invention, there is provided a method of selectively producing “American” coffee and “espresso” coffee from the same capsule of ground coffee, as claimed in claim 1 and, preferably, in any one of the following claims depending directly or indirectly on claim 1.

According to the present invention, there is also provided an infusion device for selectively producing “American” coffee and “espresso” coffee from the same capsule of ground coffee, as claimed in claim 13 and, preferably, in any one of the following claims depending directly or indirectly on claim 13.

### BRIEF DESCRIPTION OF THE DRAWINGS

A non-limiting embodiment of the invention will be described by way of example with reference to the accompanying drawings, in which:

FIG. 1 shows a sectional exploded view, with parts removed for clarity, of a first preferred embodiment of the infusion device according to the present invention;

FIGS. 2 and 3 are sectional views of the FIG. 1 device in respective different operating configurations;

FIG. 4 shows a view along line IV-IV in FIG. 1; and

FIGS. 5 and 6 show larger-scale views of respective details of FIG. 1.

### BEST MODE FOR CARRYING OUT THE INVENTION

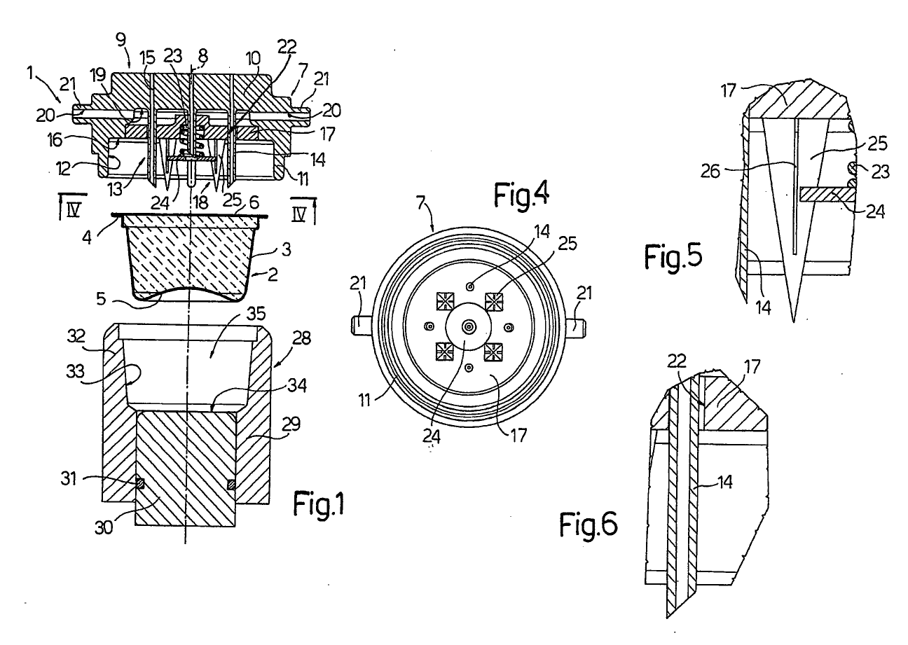

Number 1 in FIG. 1 indicates as a whole an infusion device for selectively producing an “American” and “espresso” coffee beverage from a capsule 2 of ground coffee.

More specifically, capsule 2 is a sealed capsule defined by a cup-shaped body of thermoplastic material having a truncated-cone-shaped tubular lateral wall 3, which has an outer annular flange 4 at its major base, and is closed at its minor base by a bottom wall 5. At the major base of lateral wall 3, the cup-shaped body is closed in fluidtight manner by a sealing wall 6, normally made of foil, the periphery of which is integral with the outer surface of flange 4.

Device 1 comprises a cup-shaped body 7 having a longitudinal axis 8 and defining an end portion of a pressurized-hot-water dispensing assembly 9 which, in addition to cup-shaped body 7, also comprises a known boiler (not shown) supplied with pressurized water by a known pump (not shown) and for feeding pressurized hot water to cup-shaped body 7.

Cup-shaped body 7 is defined by a top wall 10 perpendicular to axis 8, and by a tubular appendix 11, which extends along axis 8 from top wall 10, is bounded internally by a cylindrical surface 12 coaxial with axis 8, and has an inside diameter approximately equal to but no smaller than the outside diameter of flange 4 of capsule 2.

Top wall 10 is fitted with a piercing device 13 comprising five hollow injection needles 14, which are integral with top wall 10, extend from top wall 10 into appendix 11 in a direction parallel to axis 8, and, in use, as explained below, pierce sealing wall 6 to inject capsule 2 with pressurized hot water, which is fed to injection needles 14 along respective feed conduits 15 formed through top wall 10 and connected (in a manner not shown), at the opposite ends to those communicating with respective injection needles 14, to an outlet of the known boiler (not shown).

As shown in FIG. 1 and more clearly in FIG. 4, of the five injection needles 14, a shorter one is positioned coaxially with axis 8, and the other four, longer and the same length as one another, are equally spaced about axis 8 and project slightly from the free end edge of appendix 11.

On a surface 16 perpendicular to axis 8 and enclosed by appendix 11, top wall 10 of cup-shaped body 7 has a cavity closed by a fixed plate 17, which forms part of a piercing device 18 and defines, inside the cavity, a catch chamber 19 communicating externally via two coffee discharge conduits 20 crosswise to axis 8 and formed, diametrically opposite each other (FIG. 4), partly through top wall 10 and partly through respective cylindrical fittings 21 integral with top wall 10.

As shown in FIGS. 1 and 4, injection needles 14 extend through catch chamber 19 and plate 17, and are each inserted through a respective through hole 22 formed in plate 17.

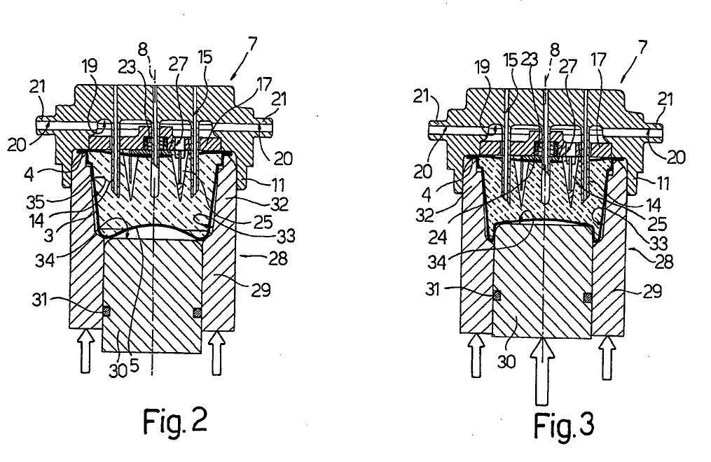

Plate 17 also comprises a cylindrical dead hole coaxial with axis 8 and defining a seat for one end of a spring 23, which is coiled about the injection needle 14 coaxial with axis 8—hereinafter indicated 14a—and is fitted on its free end with a disk 24 coaxial with axis 8 and slotted centrally to permit passage of injection needle 14a through disk 24 as disk 24 moves axially between a normal position detached from plate 17 (FIG. 1), and in which injection needle 14a is positioned inwards of disk 24, and a position adhering to plate 17 (FIGS. 2 and 3), and in which injection needle 14a projects from disk 24.

In addition to plate 17, piercing device 18 also comprises four extraction needles 25 integral with plate 17, spaced all around disk 24, and extending from plate 17 in a direction parallel to axis 8. As shown in FIGS. 4 and 5, each extraction needle 25 is pyramid-shaped with a square base, and has four lateral through slits 26, each of which is formed centrally on a respective face of relative extraction needle 25, extends along said face from plate 17 to just short of the free end of relative extraction needle 25, and is narrow enough not to let through minimum-diameter grains of the impregnated ground coffee.

As shown in FIGS. 2 and 3, each extraction needle 25 also comprises a hollow base portion connecting relative slits 26 to a respective through discharge hole 27 formed through plate 17 to allow the percolated coffee, in use, to flow through slits 26 and hole 27 into catch chamber 19 and then into discharge conduits 20.

Finally, infusion device 1 comprises a hydraulic cylinder 28 facing appendix 11 and comprising a substantially cylindrical outer sleeve 29 coaxial with axis 8, and a piston 30 mounted to slide axially, under the control of a known actuating device not shown, along sleeve 29.with the interposition of an annular seal 31.

As shown in FIG. 1, at the end facing cup-shaped body 7, sleeve 29 comprises an end portion 32 bounded internally by an outwardly-flaring, truncated-cone-shaped surface 33, and piston 30 has a flat end surface 34 perpendicular to axis 8 and defining—together with truncated-cone-shaped surface 33, and when piston 30 is in a withdrawn rest position—a truncated-cone-shaped seat 35 coaxial with axis 8 and for housing a capsule 2 with its flange 4 resting on a free edge of end portion 32.

Sleeve 29 has an outside diameter approximately equal to but no larger than the inside diameter of tubular appendix 11, and is mounted to move, in use, along axis 8—under the control of a further known actuating device (not shown) independent of the actuating device (not shown) of piston 30—from a withdrawn rest position (FIG. 1), in which sleeve 29 is fully detached from cup-shaped body 7, and a forward operating position (FIGS. 2 and 3), in which end portion 32 is partly inserted inside appendix 11 and presses flange 4 of a capsule 2, housed inside seat 35, in fluidtight manner between the free edge of end portion 32 and end surface 16 of top wall 10.

Operation of infusion device 1 will now be described as of the FIG. 1 operating configuration, in which sleeve 29 and piston 30 are set to the respective withdrawn rest positions, and a capsule 2 is inserted by the user inside seat 35, with sealing wall 6 facing cup-shaped body 7, and with flange 4 resting on the free edge of end portion 32 of sleeve 29.

When infusion device 1, as yet idle, is activated, sleeve 29 and piston 30 move together (FIG. 2) towards cup-shaped body 7 until sleeve 29 reaches the forward operating position described above. It should be pointed out that, during this movement, seat 35 remains undeformed, and, over the last portion of the movement, injection needles 14 and extraction needles 25 gradually penetrate capsule 2, and disk 24 is pushed into the position adhering to plate 17 in opposition to spring 23.

At this point, if the user has previously selected “American” coffee, pressurized hot water is pumped through injection needles 14 into capsule 2 and, after impregnating the ground coffee in capsule 2, flows out through slits 26 in extraction needles 25 and through holes 27 into catch chamber 19 and out along discharge conduits 20.

When a stop button (not shown) is pressed by the user, the pressurized-hot-water supply is cut off; sleeve 29 withdraws, together with piston 30 and under the control of the relative actuating device (not shown), into the withdrawn rest position; and spring 23, no longer encountering any resistance from sealing wall 6, expands to push disk 24 outwards and so assist withdrawal of injection needles 14 and extraction needles 25, and detachment of capsule 2 from plate 17.

Conversely, if the user has previously selected “espresso” coffee, when sleeve 29 reaches the forward operating position, piston 30 is moved forward from the withdrawn rest position (FIG. 2) into capsule 2 to deform bottom wall 5 of capsule 2 (FIG. 3) and so reduce the inside volume of, and compact the ground coffee inside, capsule 2.

As a result of the coffee being compacted, the pressurized hot water subsequently pumped through injection needles 14 encounters greater hydraulic resistance inside capsule 2 than in the previous case, and such as to produce an emulsifying swirl in the coffee issuing through slits 26, thus forming on the coffee a so-called “cream”, i.e. a layer of coffee emulsified with air.

It should be pointed out that, as shown clearly in FIG. 3, the length of injection needles 14 and extraction needles 25 and the axial displacement of piston 30 are such that piston 30, in the extracted position, does not interfere with the tips of injection needles 14 and extraction needles 25.

1. An infusion method for selectively producing an “American” and “espresso” coffee beverage from the same capsule (2) of ground coffee, the method comprising the step of adjusting the degree of compaction of the ground coffee inside the capsule (2) as a function of the type of beverage selected.

2. A method as claimed in claim 1, wherein the degree of compaction of the ground coffee is adjusted by adjustment of an inside volume of the capsule (2).

3. A method as claimed in claim 2, wherein said adjustment ranges between zero and a given value.

4. A method as claimed in claim 1, wherein the degree of compaction of the ground coffee is adjusted by deformation of the capsule (2).

5. A method as claimed in claim 4, wherein said deformation ranges between zero and a given value.

6. A method as claimed in claim 1, and comprising the step of inserting said capsule (2) inside a seat (35); the degree of compaction of the ground coffee being adjusted by variation of a volume of said seat (35).

7. A method as claimed in claim 1, wherein said capsule (2) comprises a tubular lateral wall (3) and a first and a second end wall (5, 6); the method comprising a step of feeding pressurized hot water into the capsule (2), and a step of extracting said beverage from the capsule (2); said feeding and extracting being performed through the same said end wall (6).

8. A method as claimed in claim 1, wherein said capsule (2) comprises a tubular lateral wall (3) and a first and a second end wall (5, 6); the method comprising a step of feeding pressurized hot water into the capsule (2), and a step of extracting said beverage from the capsule (2); said feeding and extracting being performed through said first end wall (5); and the degree of compaction of the ground coffee being adjusted by applying axial compression on said second end wall (6).

9. A method as claimed in claim 1, wherein said capsule (2) is a sealed capsule (2) comprising a tubular, lateral wall (3) closed at one end by a bottom wall (5) and at the opposite end by a sealing wall (6); the method comprising a step of piercing said sealing wall (6) to feed pressurized hot water into the sealed capsule (2) and to extract said beverage from the sealed capsule (2).

10. A method as claimed in claim 1, wherein said capsule (2) is a sealed capsule (2) comprising a tubular lateral wall (3) closed at one end by a bottom wall (5) and at the opposite end by a sealing wall (6); the method comprising a step of piercing said sealing wall (6) to feed pressurized hot water into the sealed capsule (2) and to extract said beverage from the sealed capsule (2); and the degree of compaction of the ground coffee being adjusted by applying axial compression on said bottom wall (5).

11. A method as claimed in claim 8, wherein said compression is applied before the pressurized hot water is fed into the capsule (2).

12. A method as claimed in claim 9, wherein said steps of feeding pressurized hot water into the sealed capsule (2) and of extracting said beverage 10 from the sealed capsule (2) are performed by means of a number of injection needles (14) and a number of extraction needles (25) respectively; application of said compression reducing a depth of the sealed capsule (2) to a given reduced value; and, after the piercing step, said 15 injection and extraction needles (14, 25) projecting axially inside the sealed capsule (2) by a length approximately equal to but no greater than said given reduced value.

13. An infision device for selectively producing an “American” and “espresso” coffee beverage from the same capsule (2) of ground coffee, the device comprising adjusting means (30) for adjusting the degree of compaction of the ground coffee inside the capsule (2).

14. A device as claimed in claim 13, the device having a fixed axis (8) and comprising pressurized-hot-water dispensing means (9); and seating means (28) aligned with said dispensing means (9) along said axis (8) to define a seat (35) coaxial with said axis (8) and for housing a said capsule (2); said seating means (28) and said dispensing means (9) being movable along said axis (8) with respect to each other; and said adjusting means (30) forming part of said seating means (28).

15. A device as claimed in claim 14, wherein said adjusting means (30) comprise thrust means (30), which are positioned facing the dispensing means (9), at least partly define an end surface (34) of said seat (35), and are mounted to move to and from said dispensing means (9) to exert, on a capsule (2) housed, in use, inside said seat (35), such axial compression as to alter an inside volume of the capsule (2).

16. A device as claimed in claim 14, wherein said adjusting means (30) comprise a piston (30) movable along said axis (8) and defining an end surface (34) of said seat (35).

17. A device as claimed in may one of claim 14, wherein said seat (35) is designed to house a sealed capsule (2) comprising a tubular lateral wall (3) closed at one end by a bottom wall (5) and at the other end by a sealing wall (6); first and second piercing means (13, 18) being provided to penetrate, in use, a said sealed capsule (2) housed in said seat (35), so as to feed pressurized hot water into the sealed capsule (2) and to extract said beverage from the sealed capsule (2) respectively.

18. A device as claimed in claim 17, wherein said first and second piercing means (13, 18) are integral with said dispensing means (9), and respectively comprise a number of injection needles (14) and a number of extraction needles (25) extending, parallel to said axis (8), towards said seat (35), and which, in use, pierce the sealing wall (6) of a said sealed capsule (2) housed in said seat (35).

19. A device as claimed in claim 18, wherein said injection needles (14) are hollow cylindrical needles, and said extraction needles (25) are hollow, pyramid-shaped needles having lateral slits (26).
